(19) United States
(12) Patent Application Publication
(10) Pub. No.: US 2012/0262523 A1
(43) Pub. Date: Oct. 18, 2012

(54) INK TANK SYSTEM

(76) Inventors: Yaakov LEVI, Kfar Yona (IL); Arnon LEWARTOWSKI, Ramat Gan (IL)

(21) Appl. No.: 13/442,427

(22) Filed: Apr. 9, 2012

Related U.S. Application Data
(60) Provisional application No. 61/475,311, filed on Apr. 14, 2011.

(51) Int. Cl. B41J 2/175

(52) U.S. Cl. 347/93

(57) ABSTRACT

An ink tank device includes an ink tank that includes a tank stirrer for agitating a fluid contained in the ink tank. Ink may be removed from the ink tank via a tank port of the device. A chamber is located above the ink tank when the device is installed in a printing system. The chamber includes a chamber stirrer for agitating a fluid contained in the chamber. The chamber is connected to a chamber inlet port such that the chamber may receive ink via the chamber inlet port, and to a chamber outlet port such that ink may be removed from the chamber via the chamber outlet port.

### CROSS REFERENCE TO RELATED APPLICATIONS

This application claims priority from U.S. Provisional Application No. 61/475,311 filed Apr. 14, 2011 and which is incorporated herein in its entirety

### FIELD OF THE INVENTION

The present invention relates to digital printing. More particularly, the present invention relates to an ink tank system for digital printing with heavy particle inks.

### BACKGROUND OF THE INVENTION

Color printing techniques have been introduced for coloring or marking glass and ceramic substrates. In addition to the various known decorative and esthetic uses of colored glass and ceramics, the printing techniques may provide the substrate with various functional effects and advantages. Such color printing techniques may be of use in various fields, such as the automotive industry, architecture, and in home appliances and similar devices.

As an example, of a functional effect, color printing on glass may enable glass pane or window to provide shade or protection from ultraviolet or other undesirable radiation. For example, a windshield for mounting on a vehicle may be printed with a tinted border so as to shield from ultraviolet radiation the glue that holds the windshield to the vehicle frame.

Color printing may be used to mark the substrate for functional purposes, or to provide information content (e.g. a warning on a window of an appliance). The substrate may be colored for decorative or esthetic effects in architectural structures. In addition to providing color, various inks may be formulated to provide other effects, such as frosting or simulated etching.

Digital ink jet printing on glass and ceramic substrates may provide advantages over other printing methods such as screen printing. With digital printing, the pattern to be printed is digitally stored on a computer readable medium. When printing, the printing heads of a digital printing system are automatically controlled by a computer, so as to deposit the ink in the pattern determined by the stored pattern. For example, a digital ink jet printer for printing on glass has been described by Eron in WO 2005/018941.

Digital ink jet printing may thus be more efficient and increase throughput over other printing methods, such as screen printing. Preparing a pattern for digital printing may simply require designing the pattern using digital or computerized drawing tools, or scanning a pattern that was prepared using traditional coloring techniques. Screen printing, on the other hand, typically requires preparation of a new screen for each new pattern to be printed. The screen must be stored for later reuse, requiring storage space. Each color of a multicolored pattern typically requires a separate screen, which must be prepared and stored.

Printing two different patterns in succession using ink jet printing may simply require entering a series of instructions to a computer, such as loading an image file. (In some cases, further action may be necessary, such as replacing an ink tank or container.) With screen printing, printing a different pattern requires physically replacing the screen with a screen for the new pattern (and for each color of the pattern).

A single ink jet printing system may be adaptable to printing a pattern on a wide range of substrate sizes. A single pattern, once it is generated, may also, via a series of instructions to a computer, be resized (or otherwise manipulated) for printing in various contexts. With screen printing, modification of the pattern to be printed typically requires preparation of a new screen.

The ink used in ink jet printing on a glass or ceramic substrate typically includes glass or ceramic particles, e.g. in the form of glass or ceramic frits, that are suspended in a liquid. Such particles may enable the ink to adhere to or fuse with the substrate when subjected to suitable treatment, e.g. by heating. An example of such an ink is described by Magdassi et al. in U.S. Pat. No. 7,803,221. The particles may be formulated to enable the ink to provide various properties and effects.

It is an object of the present invention to provide an ink tank for an ink jet printing system for printing on a glass or ceramic substrate. It is a further object of the present invention to provide an ink delivery system for delivering an ink that includes a suspension of solid particles from the ink tank to the ink jet printing system

Other aims and advantages of the present invention will become apparent after reading the present invention and reviewing the accompanying drawings.

### SUMMARY OF THE INVENTION

There is thus provided, in accordance with some embodiments of the present invention, an ink tank device including: an ink tank including a tank stirrer for agitating a fluid contained in the ink tank; a tank port such that ink may be removed from the ink tank via the tank port; and a chamber that is located above the ink tank when the device is installed in a printing system, the chamber including a chamber stirrer for agitating a fluid contained in the chamber, the chamber being connected to a chamber inlet port such that the chamber may receive ink via the chamber inlet port, and to a chamber outlet port such that ink may be removed from the chamber via the chamber outlet port.

Furthermore, in accordance with some embodiments of the present invention, the tank port is one of a plurality of ports for mating with a coupling structure of a printing system.

Furthermore, in accordance with some embodiments of the present invention, the plurality of ports is arranged so as to enable mating said plurality of ports to, or detaching said plurality of ports from, the coupling structure using a single motion.

Furthermore, in accordance with some embodiments of the present invention, the tank stirrer or the chamber stirrer is a magnetic stirrer.

Furthermore, in accordance with some embodiments of the present invention, the ink tank is separable from and re-attachable to the device.

Furthermore, in accordance with some embodiments of the present invention, a rotation axis of the tank stirrer is vertical when the device is installed in a printing system.

Furthermore, in accordance with some embodiments of the present invention, the axis of the tank stirrer includes a conduit for conducting ink from the ink tank to the tank port.

Furthermore, in accordance with some embodiments of the present invention, a rotation axis of the chamber stirrer is horizontal when the device is installed in a printing system.

Furthermore, in accordance with some embodiments of the present invention, the chamber is provided with an overflow conduit for conducting ink from the chamber to the ink container, the inlet to the overflow conduit being situated in the chamber such that if an amount of ink in the chamber exceeds a predetermined limit, the excess ink is conducted to the ink container.

There is further provided, in accordance with some embodiments of the present invention, an ink jet printing system including: at least one coupling structure, each coupling structure being provided with plurality of ports to which a corresponding plurality of ports of an ink tank device may be mated; a mechanism for operating a stirrer of the ink tank device; and an ink supply conduit for connecting a port of the plurality of ports with a printing head for conducting ink from the ink tank device to the printing head.

Furthermore, in accordance with some embodiments of the present invention, the system includes a pump for pumping and circulating ink from an ink tank of the ink tank device to a chamber of the ink tank device.

Furthermore, in accordance with some embodiments of the present invention, the system includes a pump that is controllable to circulate ink out of a chamber of the ink tank device and back to the chamber via a circulation conduit.

Furthermore, in accordance with some embodiments of the present invention, the circulation conduit is provided with a filter for filtering ink that flows through the circulation conduit.

Furthermore, in accordance with some embodiments of the present invention, the circulation conduit is provided with a detector for detecting a change in the flow of ink through the circulation conduit.

Furthermore, in accordance with some embodiments of the present invention, the system includes a valve that is controllable to determine a flow of a fluid through a conduit of the system.

Furthermore, in accordance with some embodiments of the present invention, the system includes a vacuum pressure that is connected to a port of the coupling structure.

Furthermore, in accordance with some embodiments of the present invention, the mechanism includes a magnet.

Furthermore, in accordance with some embodiments of the present invention, the coupling structure may be mated with, or detached from, the corresponding plurality of ports using a single motion.

Furthermore, in accordance with some embodiments of the present invention, the system includes a controller for controlling components of the system.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a ink supply assembly that incorporates an ink tank device in accordance with an embodiment of the present invention.

FIG. 2A shows a partially exploded view of an ink tank device, in accordance with an embodiment of the invention.

FIG. 2B is a frontal view of the ink tank device shown in FIG. 2A, schematically showing selected internal structure.

FIG. 3 schematically shows an ink jet printing system, in accordance with an embodiment of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or non-transitory processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

An ink supply system, in accordance with embodiments of the present invention, is designed to deliver ink from an ink tank device to an ink jet printing system. The ink includes a suspension of solid particles (e.g. as described by Magdassi et al. in U.S. Pat. No. 7,803,221). For example, in a typical ink jet printing ink, typical particle sizes range from about 200 nm to about 5 μm. The ink tank device and ink supply system are designed to maintain the solid particles in suspension as the ink is stored in a tank of the device, and as the ink is delivered to the printing head by the ink jet printing system.

In order to maintain the suspension in the stored ink, the ink tank device is provided with stirrers for agitating the ink. The associated ink jet printing system may include one or more pumps for preventing settling of the suspended particles as the ink is transported through various ink supply conduits of the system.

The stirrers and pumps may inhibit the suspended particles from settling out of the ink. By maintaining the particles in suspension, a uniform quality of the ink may be maintained. In addition, clogging of various ports, openings, and conduits of the ink tank device and of the ink jet printing system may be inhibited.

The ink tank device is provided with a plurality of ports in the form of connectors. The connectors are arranged on a surface of the ink tank device. An assembly of the ink jet printing system is provided with a mating surface on which mating connectors are arranged. In this manner, by pressing the mating surfaces together, the mating sets of connectors may be connected in a single motion, installing the ink tank device in the ink jet printing system.

In accordance with some embodiments of the present invention, mating sets of connectors or mating surfaces may include one or more mechanisms for locking or fixing a connection between mating connectors. Such a mechanism may include, for example, a screw, bolt, clip, or bayonet connector. An ink tank device or printer to which it is coupled may include a release button or lever for releasing any locking mechanism to enable quick detachment.

When the ink tank device is installed in an ink jet printing system, the mating connectors connect various internal tubes, openings, and chambers of the ink tank device to corresponding conduits of the ink jet printing system. The connections enable quick (e.g. using a single motion using a single hand) connection and disconnection of the ink tank and the ink jet printing system.

For example, printing a new pattern may require a different set of ink colors than had been required by a previous printing job. In this case, an operator may replace an ink tank that contains one color (or type) of ink, with an ink tank that contains another. When printing with fewer colors than the total number of ink tanks enables, two or more ink tanks that contain a single color of ink may be installed. This may increase that number of printing heads that are employed to print that color, thus expediting the printing process.

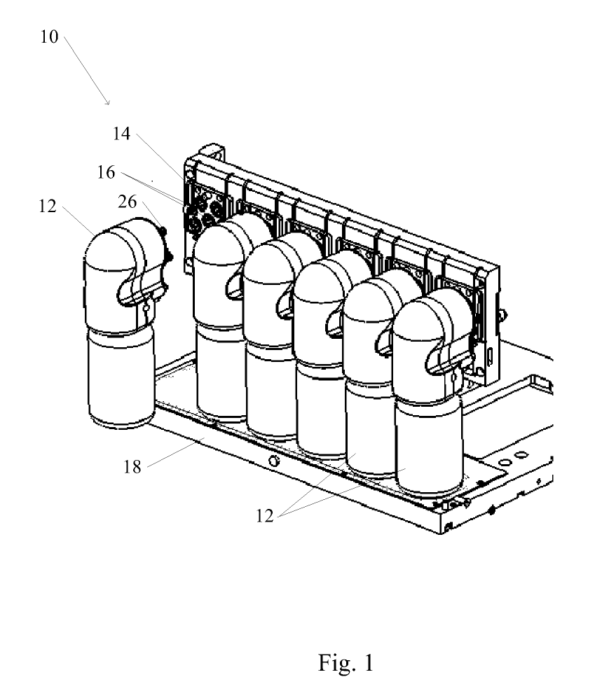

FIG. 1 illustrates an ink supply assembly that incorporates an ink tank device in accordance with an embodiment of the present invention. Ink jet ink supply assembly 10 is configured such that a plurality of ink tanks 12 (e.g. up to six, in the example shown) may be installed.

Ink supply assembly 10 includes a plurality of head assembly coupling plates 14. Each ink tank device 12 may be installed by coupling an ink tank device 12 to one of head assembly coupling plates 14. For example, a coupling nozzle 26 mounted on ink tank device 12 may be inserted into a coupling socket 16 of a head assembly coupling plate 14. Ink supply assembly 10 may also include a base plate 18 on which ink tank devices 12 may rest when they are installed. Coupling nozzles 26 and coupling sockets 16 are typically configured to enable quick connect/disconnect type secure coupling between each coupling nozzle 26 and corresponding coupling socket 16.

For example, a coupling nozzle 26, a coupling socket 16, or both, may be provided with one or more sealing gaskets or rings. Thus, when coupling nozzle 26 is inserted into coupling socket 16, friction between the gasket and the mating surface may hold coupling nozzle 26 inside coupling socket 16, while also providing a seal to prevent leakage of ink components. Alternatively or in addition, one of coupling nozzle 26 and coupling socket 16 may be provided with an appropriately shaped (e.g. axially symmetric band) indentation, and the other with a correspondingly shaped resilient protruding element (e.g. a resilient ring). Thus, when coupling nozzle 26 is inserted into coupling socket 16, the resilient protruding element on one inserts into the indentation of the other, holding coupling nozzle 26 inside coupling socket 16 (and providing sealing).

Alternatively or in addition, one or more of coupling nozzle 26, coupling socket 16, ink tank devices 12, or head assembly coupling plate 14 may be provided with one or more fixing arrangements. Such a fixing arrangement may secure a connection between a coupling nozzle 26 and a coupling socket 16. Such a fixing arrangement may include, for example, a screw, bolt, clip, or bayonet connector.

Alternatively to the arrangement shown, some or all of the coupling nozzles may be mounted on the coupling plate of the ink supply assembly, while the ink tank is provided with the corresponding coupling sockets. With all such arrangements, a motion of an ink tank perpendicular to a coupling plate of the ink supply assembly enables installation, or removal of, an ink tank in the ink supply assembly.

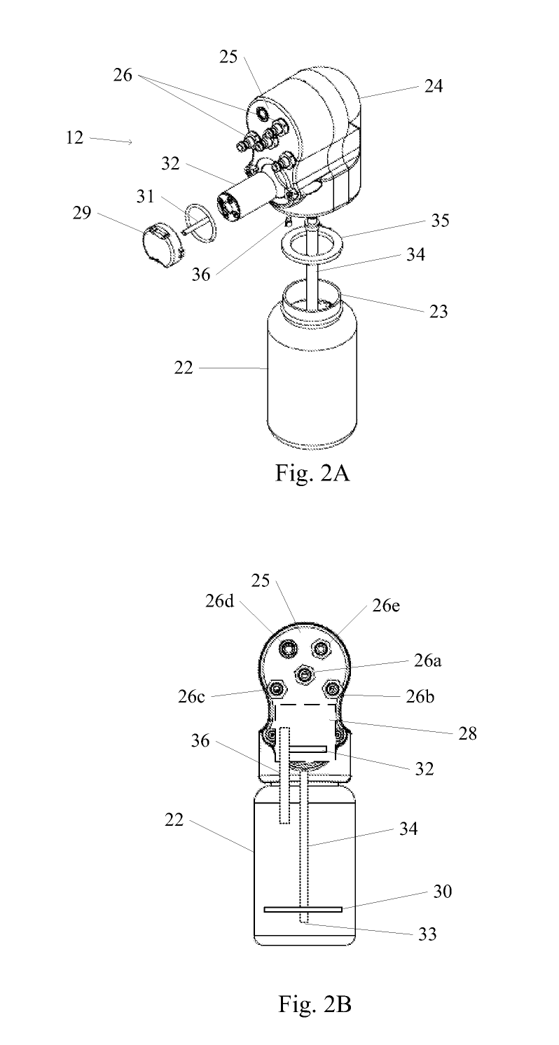

FIG. 2A shows a partially exploded view of an ink tank device, in accordance with an embodiment of the invention. FIG. 2B is a frontal view of the ink tank device shown in FIG. 2A, schematically showing selected internal structure.

Ink tank device 12 includes ink tank 22 that is detachable from ink tank upper housing 24. For example, upper lip 23 of ink tank 22 may be provided with threading or tabs that enable upper lip 23 to attach to corresponding or mating structure in an opening at the bottom of ink tank upper housing 24. Sealing gasket 35 may provide a secure seal between upper lip 23 and upper housing 24.

Ink tank 22 may be detached from ink tank upper housing 24, for example, in order to replace the type (e.g. color) of ink in the tank with another. Prior to re-attaching ink tank 22 to ink tank upper housing 24, ink tank upper housing 24 may be washed or flush to remove any remainders of the previously used ink.

For example, a separate flushing unit may be provided to which coupling nozzles 26 of ink tank device 12 or ink tank upper housing 24 may be attached. The flushing unit may then circulate a flushing fluid through the attached ink tank device 12 or ink tank upper housing 24. As another example, ink tank 22 may be filled with a flushing fluid and ink tank device 12 may then be connected to an ink jet printing system, as described below. Various pumps of the ink jet printing system may then be operated in order to flush ink tank device 12.

Ink tank upper housing 24 includes ink tank coupling plate 25. Ink tank coupling plate 25 serves as a base for a plurality of coupling nozzles 26. Each coupling nozzle 26 (numbered individually as coupling nozzles 26a-26e in FIG. 2B) enables connection to a mating connector (e.g. coupling socket 16 as shown in FIG. 1). When thus coupled, one or more internal spaces or conduits of ink tank device 12 may be connected to one or more devices or conduits that are external to ink tank device 12 (e.g. are part of ink supply assembly 10 of FIG. 1). For example, a pair of coupling nozzles 26 may enable circulation of ink through an external fluid-conveying circuit (which may include a printing head, in accordance with some embodiments of the invention).

Ink tank upper housing 24 includes overflow chamber 28 in the form of an internal cavity. When ink tank device 12 is installed in ink supply assembly 10, ink may be pumped (e.g. out a port connected to ink tank 22, via an external pump and conduit, an in a chamber inlet port connected to overflow chamber 28) from ink tank 22 to overflow chamber 28. Ink from overflow chamber 28 may be conducted to (with the ink flowing down to under gravity) or circulated through (e.g. via a coupling nozzle and an external pump and circuit) a printing head. Overflow chamber 28 is provided with drain conduit 36. When the upper surface of the ink in overflow chamber 28 exceeds the height of an upper inlet of drain conduit 36, the excess ink is drained back into ink tank 22.

Ink tank device 12 provides agitators in the form of container stirrer 30 and overflow tank stirrer 32 to agitate the ink in ink tank 22 and in overflow chamber 28.

Container stirrer 30 is mounted on shaft 34 that extends downward from ink tank upper housing 24 into ink tank 22. Thus, when ink tank 22 is attached to ink tank upper housing 24 and positioned upright, container stirrer 30 is located near the bottom of ink tank 22. Shaft 34 is hollow and serves as a conduit through which ink may flow (e.g. when pumped by an external pump) from ink tank 22 out through one of coupling nozzles 26. Placement of container stirrer 30 in close proximity to intake opening 33 of shaft 34 may facilitate the flow of well-mixed ink into the conduit of shaft 34 when container stirrer 30 is in operation.

Container stirrer 30 may be operated so as to rotate about shaft 34 (which is typically oriented in a vertical direction and in this case serves as an axis for container stirrer 30). For example, container stirrer 30 may be magnetically operated. In this case, a bearing may permit container stirrer 30 to rotate freely about shaft 34 in response to a magnetically applied torque. For example, the applied torque may be applied by a rotating magnetic structure that is incorporated into ink supply assembly 10, e.g. in base plate 18 (FIG. 1).

Alternatively to magnetic stirring, container stirrer 30 may be operated mechanically, e.g. by a motor incorporated into ink tank upper housing 24. In this case, the shaft may be rotatable, and an appropriate gasket may enable ink to flow through the shaft without leakage.

Alternatively to a stirrer, ink in ink tank 22 may be agitated by any other fluid agitation technique known in the art, including mechanically or acoustically induced shaking or vibration.

Overflow chamber 28 is provided with overflow chamber stirrer 32. Overflow chamber stirrer 32 may be operated so as to stir ink that is in overflow chamber 28. For example, overflow chamber stirrer 32 may be operated magnetically. For example, head assembly coupling plate of ink supply assembly 10 (FIG. 1) may incorporate an appropriate rotating magnetic torque-inducing device. In this case, an axis of overflow chamber stirrer 32 may be arranged horizontally. Chamber stirrer 32 is held in place by cover 29

Alternatively, an axis of an overflow stirrer 32 may be arranged collinearly or coaxially with, parallel to, or at an oblique angle to, an axis of container stirrer 30.

Alternatively to magnetic stirring, overflow chamber stirrer 32 may be operated mechanically, e.g. by a motor incorporated into ink tank upper housing 24. Alternatively, container stirrer 30 and overflow chamber stirrer 32 may be coupled to one another by a suitable transmission. In this case, application of a torque (e.g. magnetically or mechanically) to one of stirrer 30 and overflow chamber stirrer 32 causes the other to rotate as well. Alternatively to a stirrer, ink in overflow chamber 28 may be agitated by any other fluid agitation technique known in the art, including mechanically or acoustically induced shaking or vibration.

Ink from overflow chamber 28 is typically delivered via a chamber outlet port and a conduit to a printing head for deposition onto a substrate. Agitation of the ink in overflow chamber 28 may ensure that the ink that is delivered to the printing head is well mixed, and that particle components of the ink are properly suspended in the ink.

Ink tank device 12 may be provided with an identifying tag or label. For example, such a tag may be in the form of a radio-frequency identification (RFID) tag, or an optically scannable barcode. A printer or printing system to which ink tank device 12 may be installed may be provided with a corresponding tag reading device (e.g. an RFID reader or a barcode scanner). The identifying tag may include such information as the manufacturer of the device and the type of device.

An ink tank device, in accordance with embodiments of the present invention, may be incorporated into an ink jet printing system. The ink jet printing system enables delivery of ink to a printing head for deposition on a substrate, as well as maintaining its various components in working order.

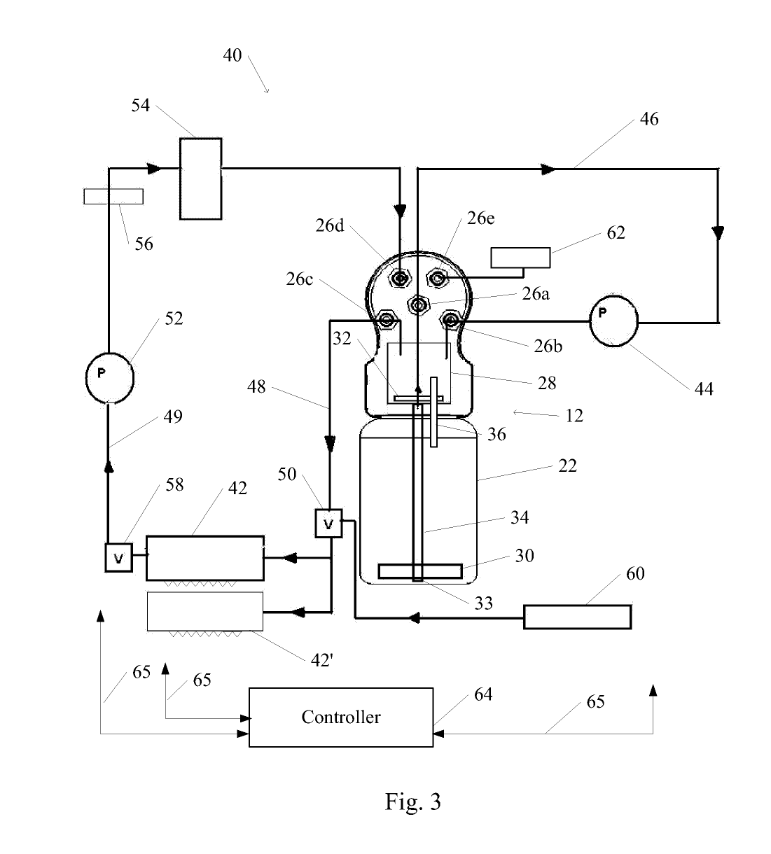

FIG. 3 schematically shows an ink jet printing system, in accordance with an embodiment of the present invention. Some or all of components of ink jet printing system 40 may be incorporated into a suitable structure, such as ink supply assembly 10 (FIG. 1).

Some components of ink jet printing system 40 may be controlled by a controller 64 (connection of controller 64 to the remainder of ink jet printing system 40 is represented in a general sense by connectors 65). Controller 64 may include one or more processors, as well as one or more data storage devices. Controller 64 may control, as well as receive signals from, one or more components of ink jet printing system 40.

Ink jet printing system 40 enables delivery of ink from ink tank device 12 to a printing head 42 (as well as one or more additional printing heads 42′). When ink tank device 12 is installed in ink jet printing system 40 (e.g. ink tank coupling plate 25, as shown in FIGS. 2A and 2B, is coupled to a head assembly coupling plate 14 of an ink supply assembly 10, as shown in FIG. 1, or to a similar coupling structure), coupling nozzles 26a-26e may be connected to various conduits and devices. (Although for the purpose of this description, coupling nozzles 26a-26e are each assigned a specific function, in other embodiments of the present invention the functions of some or all of coupling nozzles 26a-26e may be interchanged. In addition, the placement or arrangement of some or all of coupling nozzles 26a-26e on ink tank device 12 may vary in alternative embodiments of the present invention.) The various conduits and devices may serve to maintain the ink and ink jet printing system 40 in proper working condition, as well as to conduct ink to printing head 42.

Pump 44 may be operated to transfer ink from ink tank 22 to overflow chamber 28. As container stirrer 30 operates to agitate ink in ink tank 22, pump 44 may draw ink from ink tank 22 through shaft 34. Ink drawn up shaft 34 is drawn out of coupling nozzle 26a (serving as a tank port) through ink conduit line 46. (Typically, ink conduit line 46 and pump 44 are incorporated into, e.g. enclosed within or mounted to, head assembly coupling plate 14.) Ink from ink conduit line 46 is conducted through coupling nozzle 26b (serving as a chamber inlet port) into overflow chamber 28. Ink in overflow chamber 28 may be agitated by overflow tank stirrer 32. Depending on the quantity of ink in overflow chamber 28, excess ink may be drained back to ink tank 22 (e.g. gravitationally transferred) via drain conduit 36.

Thus, ink in overflow chamber 28 may be maintained at a height that is predetermined by pump 44 and by drain conduit 36. In this manner, the ink in overflow chamber 28 may be maintained an approximately constant fluid pressure relative to print head 42. Ink in overflow chamber 28 may be conducted to print head 42 for printing via coupling nozzle 26c (serving as a chamber outlet port) and head supply conduit 48. Due to the approximately constant fluid pressure of the ink in overflow chamber 28, gravitational flow may be used to deliver ink from overflow chamber 28 to print head 42, and via head supply conduit 48, at an approximately constant flow rate.

Flow of ink through head supply conduit 48 may be controlled by controlling head supply valve 50. For example, head supply valve 50 may be controlled by controller 64 to determine whether or not ink flow is enabled from ink tank device 12 to printing head 42 or additional printing head 42′.

When ink is delivered to printing head 42 (or additional printing head 42′), printing head 42 may be operated to deposit ink on a substrate.

In order to maintain the quality of the ink and to maintain the quality of head supply conduit 48, ink may be caused to flow periodically through head supply conduit 48. For example, at predetermined times (e.g. at intervals of a few minutes), or under predetermined conditions (e.g. idling condition based on a detected printing load), controller 64 may control circulation pump 52, head supply valve 50, and circulation line valve 58, to cause a circulation flow. During a circulation flow, ink is pumped out of overflow chamber 28 via coupling nozzle 26c and head supply conduit 48. Ink flows from head supply conduit 48 through printing head 42 (and additional printing head 42′) into circulation flow conduit 49. Ink in circulation flow conduit 49 then is circulated through coupling nozzle 26d back into overflow chamber 28.

Ink in circulation flow conduit 49 is made to flow through filter 54. Filter 54 may be designed to remove large particles (e.g. with diameters larger than about 5 μm) from the ink. For example, large particles may form by agglomeration of the particles (with diameters up to about 5 μm) that are suspended in the ink. Filtering of the ink by filter 54 may remove the large particles, thus maintaining the quality of the ink or preventing clogging or otherwise adversely affecting ink jet printing system 40.

Detector 56 may detect changes in the flow of ink through circulation flow conduit 49. For example, detector 56 may include a fluid flow meter. Changes in a flow rate detected by detector 56 may be indicative of a change in the state of filter 54. In particular, a decrease in fluid flow rate may indicate that filter 54 is clogged, or otherwise requires cleaning, replacing, or maintenance. Alternatively or in addition, detector 56 may include a pressure meter.

Detector 56 may transmit a signal to controller 64 that indicates a measured state of the flow of ink through circulation flow conduit 49. When such a signal is interpreted by controller 64 to indicate that filter 54 requires maintenance, a visible or audible alert or prompt may generated. A human operator monitoring ink jet printing system 40 may thus be informed to perform the required maintenance. Alternatively or in addition, when a signal generated by detector 56 indicates that filter 54 requires maintenance, operation of ink jet printing system 40 may be modified or interrupted. Alternatively or in addition, ink jet printing system 40 may incorporate a cleaning mechanism or device for flushing or otherwise cleaning filter 54.

During flow of ink through head supply conduit 48, printing head 42, or circulation flow conduit 49, fluid pressure may be reduced so as to prevent leakage of ink out of printing head 42 (e.g. through a nozzle of printing head 42). Fluid pressure may be reduced by vacuum pump 62. Vacuum pump 62 may connect to the fluid conduits associated with ink tank device 12 via coupling nozzle 26e. From coupling nozzle 26e and via head supply conduit 48, fluid pressure may be reduced in printing head 42. The reduction in pressure may be sufficient to enable ambient atmospheric pressure and surface tension of the ink to prevent outward leakage of ink from printing head 42.

Controller 64 may control ink jet printing system 40 to clean or flush the system. For example, valve 50 may be controlled such that a cleaning fluid from cleaning fluid tank 60 is caused to circulate through printing head 42 (and additional printing head 42′). The cleaning fluid may also circulate through one or more conduits or other devices of ink jet printing system 40. For example, flushing ink jet printing system 40 may take place at predetermined intervals, under predetermined conditions (e.g. printing load or after idling), or when initiated by an operator of ink jet printing system 40.

An ink tank device or an ink supply assembly may be separable from an ink jet printing system, e.g. when not in use. When thus separated, the ink tank device (or assembly) may be coupled to an ink circulation device or system. When so coupled, ink in the ink tank device may continue to be stirred, circulated, or both such that the ink in the ink remains usable and ready for use upon being reattached to an ink jet printing system. For example, an ink jet printing system may be provided with a standby ink stirring shelf or assembly to which an ink tank device may be connected when not in use. The standby shelf may be part of a printer, or may be separate device or structure.

1. An ink tank device comprising:
an ink tank including a tank stirrer for agitating ink contained in the ink tank;
a tank port to enable removal of ink from the ink tank via the tank port; and
a chamber that is located above the ink tank when the device is installed in a printing system, the chamber including a chamber stirrer for agitating ink that is contained in the chamber, the chamber being connected to a chamber inlet port to enable the chamber to receive ink via the chamber inlet port, and to a chamber outlet port to enable removal of ink from the chamber via the chamber outlet port.

2. The device of claim 1, wherein the tank port, the chamber inlet port, or the chamber outlet port is one of a plurality of ports for mating with a coupling structure of a printing system.

3. The device of claim 2, wherein the plurality of ports is arranged so as to enable mating said plurality of ports to, or detaching said plurality of ports from, the coupling structure using a single motion.

4. The device of claim 1, wherein the tank stirrer or the chamber stirrer is a magnetic stirrer.

5. The device of claim 1, wherein the ink tank is separable from and attachable to a housing containing the chamber.

6. The device of claim 1, wherein the axis of the tank stirrer is vertical when the device is installed in a printing system.

7. The device of claim 1, wherein the axis of the tank stirrer comprises a conduit for conducting ink from the ink tank to the tank port.

8. The device of claim 1, wherein a rotation axis of the chamber stirrer is horizontal when the device is installed in a printing system.

9. The device of claim 1, wherein the chamber is provided with an overflow conduit for conducting ink from the chamber to the ink tank, the inlet to the overflow conduit being situated in the chamber such that if an amount of ink in the chamber exceeds a predetermined limit, excess ink is conducted to the ink tank.

10. An ink jet printing system comprising:
at least one coupling structure, each coupling structure being provided with plurality of ports for mating with a corresponding plurality of ports of an ink tank device;
a mechanism for operating a stirrer of the ink tank device; and
an ink supply conduit for connecting a port of the coupling structure with a printing head for conducting ink from the ink tank device to the printing head.

11. The system of claim 10, comprising a pump for pumping ink from an ink tank of the ink tank device to a chamber of the ink tank device.

12. The system of claim 10, comprising a pump that is controllable to circulate ink out of a chamber of the ink tank device and back to the chamber via a circulation conduit.

13. The system of claim 12, wherein the circulation conduit is provided with a filter for filtering ink that flows through the circulation conduit.

14. The system of claim 12, wherein the circulation conduit is provided with a detector for detecting a change in the flow of ink through the circulation conduit.

15. The system of claim 10, comprising a valve that is controllable to determine a flow of a fluid through a conduit of the system.

16. The system of claim 10, comprising a vacuum pump that is connected to a port of the coupling structure.

17. The system of claim 10, wherein the mechanism comprises a magnet.

18. The system of claim 10, wherein the plurality of ports of the coupling structure are capable of being mated with, or being detached from, said corresponding plurality of ports using a single motion.

19. The system of claim 10, comprising a controller for controlling components of the system.
